(19) United States
(12) Patent Application Publication
(10) Pub. No.: US 2005/0139239 A1
(43) Pub. Date: Jun. 30, 2005

(54) Electrostatic hand cleanser apparatus and method of use

(76) Inventor: Gary L. Prae, Hoschton, GA (US)

Correspondence Address: TRASK BRITT, P.O. BOX 2550, SALT LAKE CITY, UT, 84110, US

(21) Appl. No.: 10/964,593

(22) Filed: Oct. 12, 2004

Related U.S. Application Data
(60) Provisional application No. 60/510,763, filed on Oct. 13, 2003.

(51) Int. Cl. B08B 3/00; A46B 1/00

(52) U.S. Cl. 134/34

(57) ABSTRACT

An electrostatic hand cleansing apparatus is disclosed. The electrostatic hand cleansing apparatus may be configured to expose a hand to cleansing substances, remove at least one contaminant therefrom, ameliorate the presence of at least one undesirable agent thereon, or combinations thereof. The electrostatic hand cleansing apparatus may include at least one electrostatic spray nozzle having an emission tip configured to emit an atomized, electrically charged substance. Further, a collection structure may be configured with a recess to collect a substance emitted from the at least one electrostatic spray nozzle. The collection structure may include an aperture formed therein for removing gas therethrough from the recess thereof. A sensor configured to indicate the presence of at least one hand proximate the at least one electrostatic spray nozzle is disclosed. The sensor may be configured to measure a contamination characteristic of a hand proximate thereto. A method of use is also disclosed.

### RELATED APPLICATIONS

This application claims the benefit of U.S. Provisional Patent Application Ser. No. 60/510,763, filed Oct. 13, 2003, and entitled ELECTROSTATIC HAND CLEANSER APPARATUS AND METHOD OF USE.

### BACKGROUND OF THE INVENTION

1. Field of the Invention

The present invention relates to cleansing at least one hand. More particularly, the present invention relates to hand cleaning and drying devices for automatically cleansing and drying of at least one hand. For instance, at least one electrostatic spray nozzle may be employed by an electrostatic hand cleansing apparatus of the present invention to emit one or more various substances onto at least one hand of a person.

2. State of the Art

Many applications exist for washing or cleansing hands. In general, one purpose for cleansing hands may be to remove foreign matter therefrom. Another purpose for cleaning hands may be to minimize the transmission of bacteria or other undesirable agents. Such may be the case concerning health care practitioners, who, in the interest of their patients and others, may be required to cleanse their hands repeatedly. Such repeated hand cleansing may cause irritation or damage to the skin of such practitioners. Of course, many other needs exist for the cleaning of hands. Therefore, a number of automatic hand washing apparatus have been developed, some of which as are outlined below.

U.S. Pat. No. 4,145,769 to MacFarlane et al. discloses a hand washing and drying apparatus including a first manually operable control device for causing operation of a solenoid operated valve to deliver hand washing water directly into a bowl for a preselected period of time. A second manually operable control device is provided for causing operation of a forced air drying structure to provide hand drying air to the bowl.

U.S. Pat. Nos. 4,336,619 and 4,295,233 to Hinkel et al., disclose hand washing and drying devices having a push button device for controlling the automatic delivery of warm water for a predetermined time and a push button device for controlling the automatic delivery of hand drying air for a preselected period of time.

U.S. Pat. No. 4,398,310 to Lienhard discloses a hand washing device which is triggered by a light barrier. The hand washing device comprises a control system for regulating the moistening, washing, rinsing, and drying stages of the washing process.

U.S. Pat. No. 4,606,085 to Davies discloses an electro mechanical-electronic circuit that is provided with time elements which are initiated by the flow of water to dispense hand cleaning agents. The hand washing device has a wash cycle, a rinse cycle, and an emollient dispensing cycle.

U.S. Pat. No. 5,522,411, to Johnson discloses a portable hand washing and drying unit including a housing having an opening for receiving the hands of the user. The opening of the housing is closed via a door when not in use. The hand washing and drying chamber of the housing is provided with a cleaning liquid reservoir and an electrically powered fan for providing a flow of air to dry the hands. The user manually operates a valve to dispense the cleaning liquid and manually operates a switch for turning on the fan to dry the hands.

Of further interest is the distribution of the materials used in the process of cleansing hands. Particularly, water, detergents, disinfectants, as well as other substances may be used to cleanse hands and, therefore, efficient and effective distribution of such substances is desirable. Of course, effectively distributing the hand cleansing substances may conserve these resources. In addition, efficient distribution of hand cleansing agents over the surface of the hands may also more effectively cleanse hands.

Yet another consideration pertaining to the use of automatic hand washing apparatus, and particularly to the use of electrostatic hand cleansing equipment, is safety. Electrical charges may accumulate on a user via the electric charges generated on the substances that pass through and are emitted by an electrostatic spray nozzle. However, usually these levels of electrical charge may be fairly safe, if the time of exposure and amount of electrical charge is reasonably limited. On the other hand, electrostatic spray nozzles often require relatively high voltage, 5,000 to 16,000 volts, during operation. The relatively high voltages required to operate electrostatic spray nozzles may pose a hazard during use and may therefore require that the electrostatic spray nozzle is protected from contact by a person.

U.S. Pat. No. 5,863,497 to Dirksing (hereinafter “Dirksing”) discloses a hand sanitizing apparatus which includes at least two electrostatic emitters to dispense germicidal fluid to substantially all the surfaces of a user's hands when each hand is placed in proximity to one of the two electrostatic emitters. The apparatus may include two cells which separate spray directed at one hand from spray directed at the other hand, a reservoir of germicidal fluid in fluid communication with the electrostatic emitters, a power source adapted to supply electrostatic energy to the electrostatic emitters, which may be about 5,000 to 15,000 volts. Dirksing further discloses, that in order to minimize the effects of static build up, each hand may sprayed with an opposite charge, each hand may be sprayed by multiple electrostatic emitters having opposite charges, the electrostatic emitter directed at each hand may be pulsed such that each pulse has an opposite charge, or the user may be grounded. Dirksing also suggests that grounding is not preferred because it cannot be guaranteed effective. In addition, grounding the user may be dangerous as providing an electrical path from the high voltage used to energize the electrostatic spray nozzle through the user to an electrical ground.

However, there have been advancements in the field of electrostatic spray nozzles that allow for a relatively high level of spray charging at relatively low electrode voltages and power. For example, U.S. Pat. No. 5,765,761 and U.S. Pat. No. 5,704,554 describe induction charging spray nozzles that are suitable for use with conductive liquids, solutions, suspensions or emulsions. Such electrostatic spray nozzles may be used at relatively low voltages, for instance, about 1,300 volts.

U.S. Pat. No. 6,387,081 to Cooper discloses an apparatus and method for electrostatically coating a human with a coating composition that may include the induction spray nozzles as disclosed in U.S. Pat. Nos. 5,765,761 and 5,704,554. The apparatus may include an enclosure; a mount positioned on the enclosure; an electrostatic spray nozzle connected to the mount, such as the above-referenced low-voltage nozzles, the electrostatic spray nozzle for passing the coating composition; and a grounding connection positioned inside the enclosure, the grounding connection capable of electrically grounding the human; wherein the coating composition passed through the electrostatic spray nozzle is depositable upon the human.

As may be seen from the prior art systems including electrostatic spray nozzles, many employ high-voltage electrostatic spray nozzles. Further, some of these systems employ configurations and equipment that is more complicated and may occupy more space than is desirable. Accordingly, in light of the prior art systems, while they may function as desired, it would be an advancement in the art to provide an improved electrostatic hand cleansing apparatus and method employing same.

### BRIEF SUMMARY OF THE INVENTION

The present invention relates to a cleansing apparatus for cleansing at least one hand. Generally, the electrostatic hand cleansing apparatus of the present invention may be configured to remove at least one contaminant from a hand, render the presence of at least one undesirable agent upon a hand innocuous, or both. More specifically, the present invention includes at least one electrostatic spray nozzle having an emission tip configured to emit an atomized, electrically charged substance. For instance, the at least one electrostatic spray nozzle may emit air, water, detergent, antibacterial agents, germicidal agents, ethyl alcohol, and isopropyl alcohol in order to cleanse at least one hand. In addition, the electrical charge of a substance emitted from the at least one electrostatic spray nozzle may be selectively altered to enhance the cleansing of at least one hand.

The electrostatic hand cleansing apparatus of the present invention may further include a collection structure configured to collect an electrically charged substance emitted from the at least one electrostatic spray nozzle. Accordingly, the collection structure may comprise a vessel defining a recess having a depth and may be oriented generally oppositely to the expected direction of the atomized, electrically charged emission of the at least one electrostatic spray nozzle. Also, the at least one electrostatic spray nozzle emission tip may be positioned within about 2 times the depth of the recess therefrom. The present invention contemplates that the collection structure may be electrically configured to either attract or repel an electrically charged substance emitted from the at least one electrostatic spray nozzle. The electrostatic hand cleansing apparatus may include a hood for further enhancing collection of electrically charged substances emitted from the at least one electrostatic spray nozzle. The collection structure may also include an aperture formed therein for removing gas therethrough from the recess of the collection structure.

In addition, the electrostatic hand cleansing apparatus of the present invention may include a sensor configured to indicate the presence of at least one hand positioned generally between the at least one electrostatic spray nozzle and the collection structure. More particularly, the sensor may comprise a photoelectric sensor. The sensor may be configured to interact with a user of the electrostatic hand cleansing apparatus. For instance, the user may be able to select a desired cleansing process through interaction with the sensor. Also, the sensor may be configured to measure a contamination characteristic of at least one hand positioned proximate thereto. Such a configuration may allow the electrostatic hand cleansing apparatus to operate substantially automatically.

Thus, generally, the electrostatic hand cleansing apparatus of the present invention may be configured to expose at least one hand to cleansing substances. In addition, the electrostatic hand cleansing apparatus of the present invention may be configured to substantially remove any cleansing substances from at least one hand so exposed. For instance, the electrostatic hand cleansing apparatus may substantially remove cleansing substances by drying the at least one hand. Accordingly, the electrostatic hand cleansing apparatus may operate according to any number of cycles. For instance, the electrostatic hand cleansing apparatus may include a detergent cycle, rinse cycle, sanitize cycle, and a dry cycle. Of course, other cycle arrangements as well as other cycles may be developed and utilized by the electrostatic hand cleansing apparatus of the present invention.

### BRIEF DESCRIPTION OF THE SEVERAL VIEWS OF THE DRAWINGS

The foregoing and other advantages of the present invention will become apparent upon review of the following detailed description and drawings in which:

FIG. 1 shows a schematic side view of the electrostatic hand cleansing apparatus of the present invention;

FIG. 2 shows a schematic front view of the electrostatic hand cleansing apparatus of the present invention;

FIG. 3 shows a schematic top view of the electrostatic hand cleansing apparatus of the present invention;

FIG. 4A shows a schematic side view of the electrostatic hand cleansing apparatus shown in FIGS. 1-3 of the present invention during operation;

FIG. 4B shows a schematic side view of another embodiment of an electrostatic hand cleansing apparatus of the present invention during operation;

FIG. 4C shows an enlarged side view of the electrostatic spray nozzle and the collection structure as shown in FIGS. 1-2;

FIG. 4D shows a schematic side view of the electrostatic hand cleansing apparatus shown in FIG. 4A including a grounding mat;

FIG. 4E shows a schematic side view of the electrostatic hand cleansing apparatus shown in FIG. 4A including two electrostatic spray nozzles;

FIG. 5 shows a schematic view of a water delivery system of the present invention;

FIG. 6 shows a schematic view of an air delivery system of the present invention;

FIG. 7 shows a schematic view of a detergent injection system of the present invention;

FIG. 8 shows a schematic view of a substance delivery system of the present invention; and

FIG. 9 shows a schematic view of a blower system of the present invention.

### DETAILED DESCRIPTION OF THE INVENTION

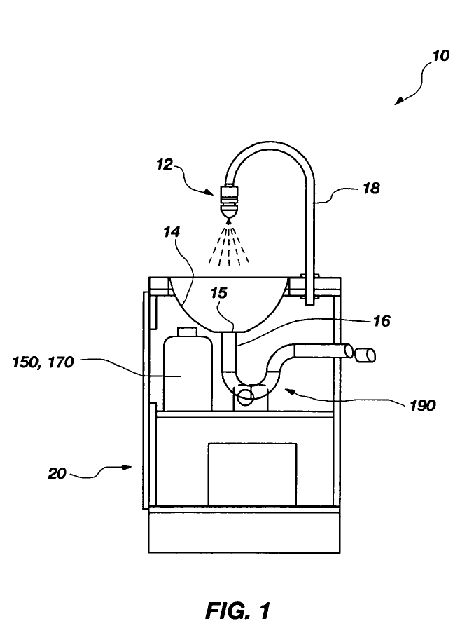

FIGS. 1-3 show an electrostatic hand cleansing apparatus 10 of the present invention including an electrostatic spray nozzle 12, and collection structure 14, each of which is affixed to housing 20. Housing 20 may comprise a cabinet or enclosure and may have one or more hinged doors providing for access into the interior thereof. Accordingly, housing 20 may be sized and configured to allow assembly of components or systems of the electrostatic hand cleansing apparatus 10 to be disposed therein. Such a configuration may allow the electrostatic hand cleansing apparatus 10 to be relatively modular.

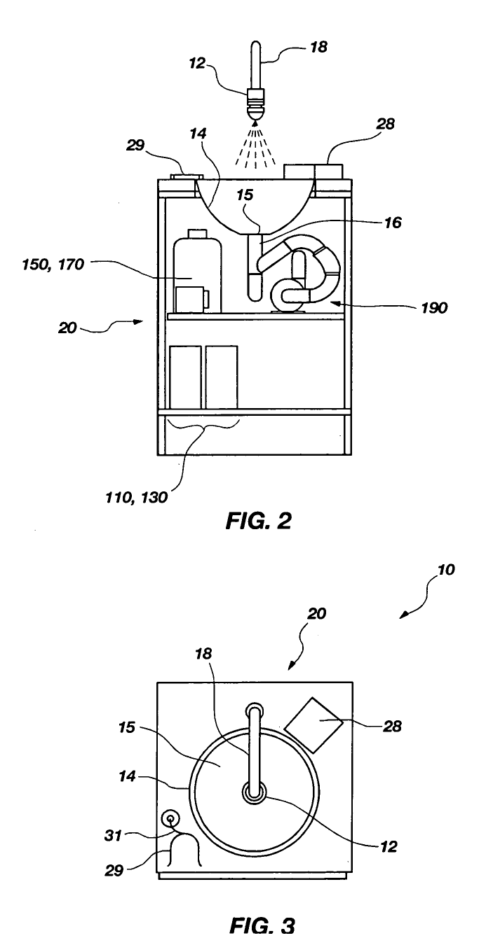

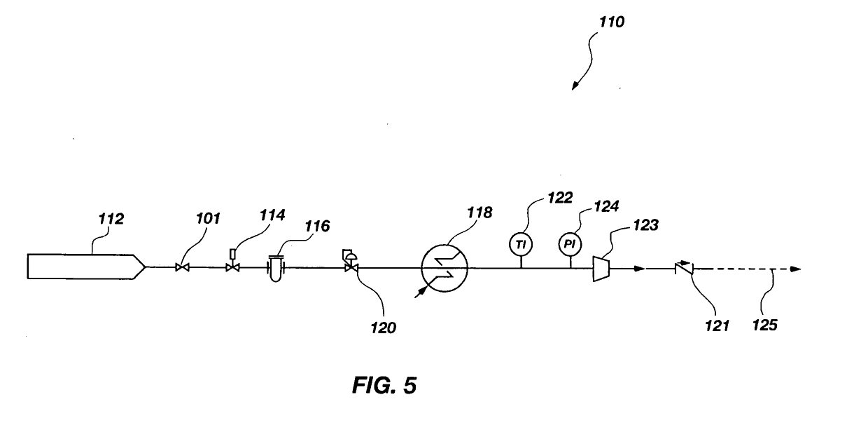

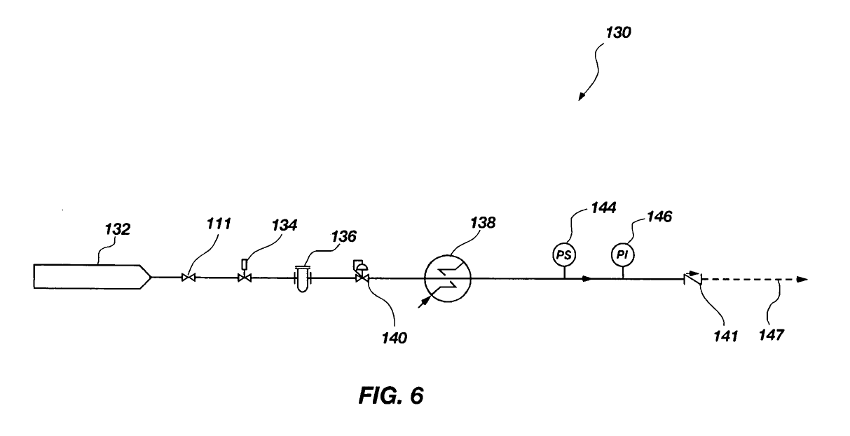

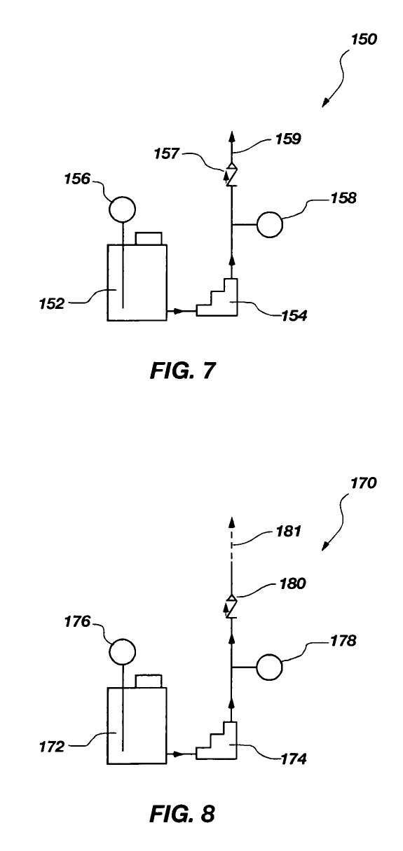

As shown in FIG. 2, water system 110 and air system 130 may be located within housing and operably connected to electrostatic spray nozzle 12. Water system 110 and air system 130 may include a supply source, if needed, treatment systems, and heating apparatus, as described in more detail below in reference to FIGS. 5 and 6. In addition, detergent injection system 150 and substance injection system 170, as shown in FIGS. 1, 2, 4A, 4B, 4D, and 4E may be configured to deliver a detergent or substance to the electrostatic hand cleansing apparatus 10 as described in more detail in reference to FIGS. 7 and 8 below.

Electrostatic spray nozzle 12 includes emission tip 19 and also may include electrical connections and pressurized gas and fluid conduits for operation thereof. Particularly, the electrostatic spray nozzle 12 may be configured in accordance with the electrostatic spray nozzles disclosed in U.S. Pat. Nos. 5,765,761 and 5,704,554, the disclosure of each of which is incorporated in its entirety by reference herein, respectively. For instance, electrostatic spray nozzles manufactured and sold by Electrostatic Spraying Systems, Inc., of Watkinsville, Ga., such as Maxcharge® electrostatic spray nozzles, may be used within the electrostatic hand cleansing apparatus 10 of the present invention. Thus, the electrostatic spray nozzle of the present invention may be operated at a relatively low voltage, for instance, at most about 1300 volts. As shown in FIGS. 1-4B, electrostatic spray nozzle 12 may be affixed to a mounting element 18 that orients and positions the electrostatic spray nozzle 12.

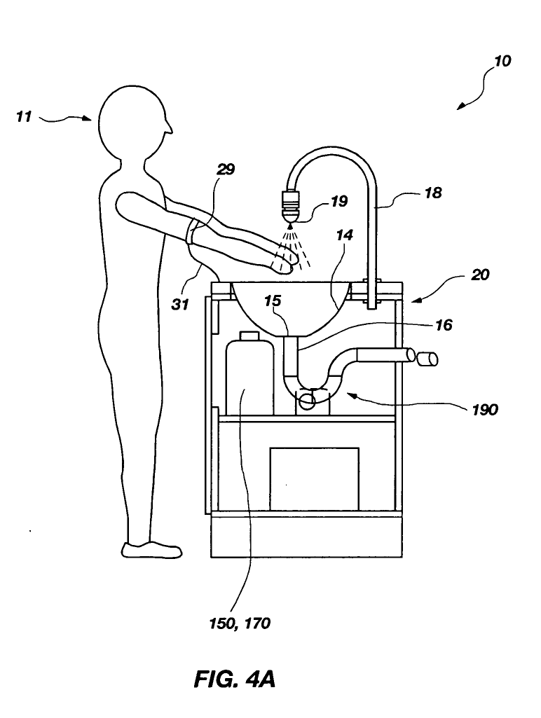

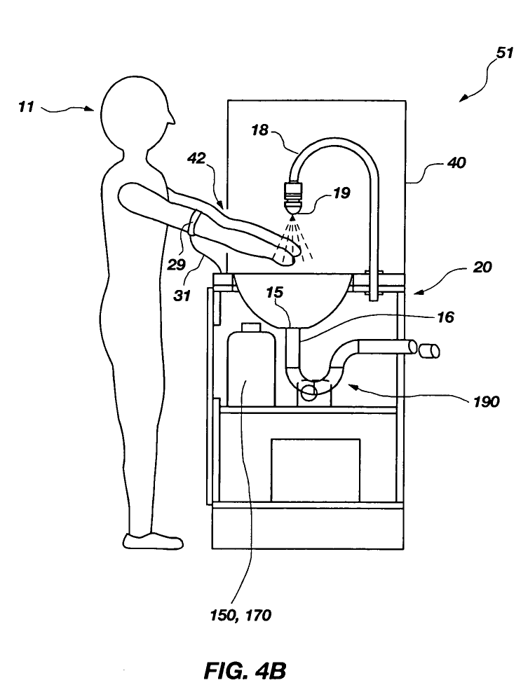

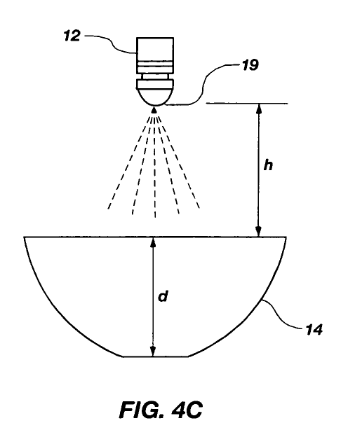

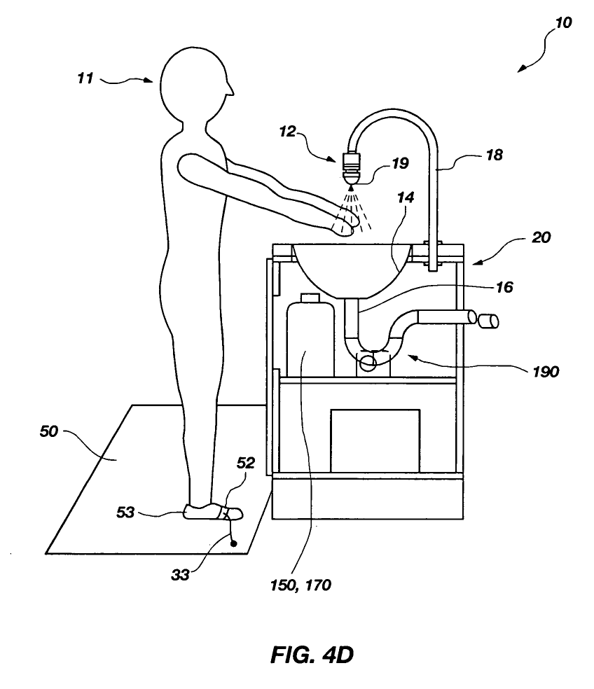

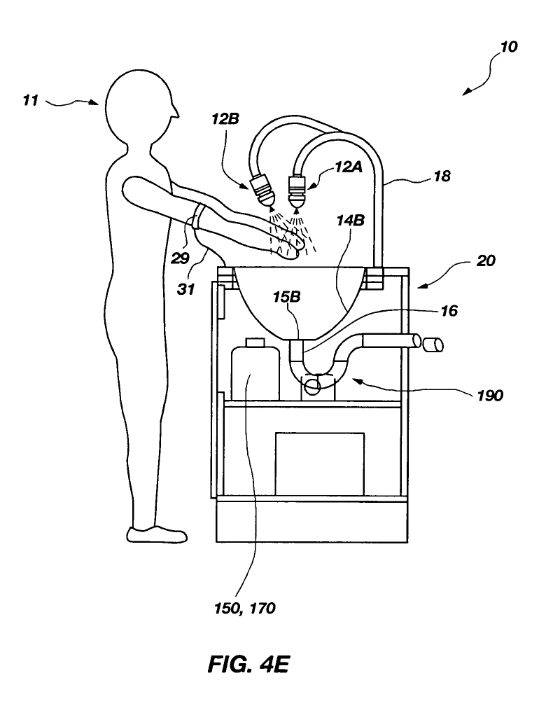

Collection structure 14 may be disposed generally opposite to the direction of emission of the electrostatic spray nozzle 12. Accordingly, the collection structure 14 may be configured to capture, collect, accumulate, or amass one or more substances emitted from the electrostatic spray nozzle 12. Therefore, the collection structure 14 may be configured as an indentation that is disposed generally opposite to the direction of emission of the electrostatic spray nozzle 12. The substances emitted from the electrostatic spray nozzle 12 may, of course, contact at least one hand of the user 11 (FIGS. 4A and 4B) of the electrostatic hand cleansing apparatus 10 prior to collection within the collection structure 14. Alternatively, substances emitted from the electrostatic spray nozzle 12 may pass from the electrostatic spray nozzle 12 into the collection structure 14.

Collection structure 14 may comprise a vessel defining a partial, generally hemispherical recess oriented generally oppositely in relation to the direction of emission of the electrostatic spray nozzle 12. Also, to facilitate collection of substances emitted by the electrostatic spray nozzle 12, the electrostatic spray nozzle 12 may be positioned relatively near the collection structure 14. Particularly, the emission tip 19 of the electrostatic spray nozzle 12 may be positioned within a distance from the collection structure 14 of about 2 times the depth of the collection structure 14. As shown in FIG. 4C, distance h, the distance between the emission tip 19 and the collection structure 14, may be up to about 2 times distance d, the depth of the collection structure 14. Further, as shown in FIG. 3, the emission tip 19 may be generally centered within the exposed area 15 of the collection structure 14. Put another way, the direction of emission of the electrostatic spray nozzle 12 may be oriented so that the emission is substantially centered within the exposed area 15 of the collection structure 14. Such a configuration may enhance the collection of substances emitted from the electrostatic spray nozzle 12 by the collection structure 14.

Of course, many recess geometries for collection structure 14 are contemplated by the present invention, including generally rectangular, generally elliptical, and generally arcuate. Collection structure 14 may further include an aperture 15 formed in the collection structure 14 and in communication with the recess with which conduit 16 may be aligned. Conduit 16 may be configured to convey or conduct substances collected within the recess of collection structure 14 therefrom. As shown in FIG. 1, conduit 16 may extend outside of housing 20 in order to connect with an external drain.

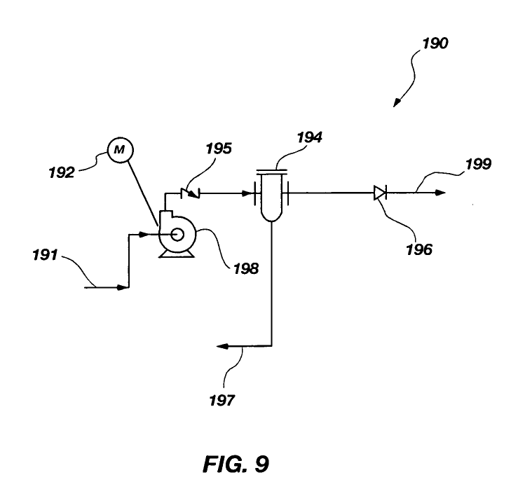

Collection structure 14 and conduit 16 may be configured to collect solids, liquids, or gasses. Accordingly, liquids dispersed from the electrostatic spray nozzle 12 or leaving at least one hand of a user 11 (FIGS. 4A and 4B) of the electrostatic hand cleansing apparatus 10 may be collected by the conduit. In addition, the conduit 16 may be used to draw air through, in order to more effectively collect substances emitted from the electrostatic spray nozzle 12. Particularly, blower system 190, described in more detail in relation to FIG. 9, may be configured to pull or draw air from the conduit 16. Therefore, the recess of collection structure 14 and aperture 15 may be sized, positioned, and configured for drawing air therethrough from within the collection structure 14. Such a configuration may enhance the retention of or capture of emission from the electrostatic spray nozzle 12.

Of course, the shape, size, and configuration of the recess of collection structure 14 may also be tailored to influence the flow patterns of air near or within the recess of collection structure 14 so as to substantially retain or capture emission from the electrostatic spray nozzle 12. Of course, the rate at which air is removed from the recess of collection structure 14 may also be altered or configured in order to influence the flow patterns of air drawn into or from the collection structure 14 so as to substantially retain or capture emissions from the electrostatic spray nozzle 12. As a further advantage, in such a configuration, air drawn through conduit 16 may facilitate drying of at least one hand in proximity to the collection structure 14, by drawing air past the at least one hand as it is drawn into the conduit 16.

In another aspect of the present invention, collection structure 14 may be electrically configured to enhance collection of substances emitted from the electrostatic spray nozzle 12. Specifically, at least a portion of the collection structure 14 may be electrically charged oppositely to the electric charge of the substance emitted from the electrostatic spray nozzle 12 or may be grounded. Of course, at least a portion of the collection structure 14 may be electrically charged with a same electric charge as the electrically charged substance emitted from the electrostatic spray nozzle 12, thereby repelling the electrically charged substance. Electrically configuring the collection structure 14 may generate electrical forces on the charged droplets or particles, thereby influencing collection thereof. A collection structure 14 that is electrically charged may also comprise an electric insulator, preferably on its outer surface so as to prevent inadvertent electric shock to a user 11 (FIGS. 4A and 4B). In addition, the shape of the recess of collection structure 14 may be tailored to enhance the electric field emanating from a charged surface or portion thereof. Also, the electric charge of the collection structure 14 may be time varying, reversed, or any combination thereof. Such a combination may more effectively expose at least one hand of a user 11 (FIGS. 4A and 4B) to the emitted substance.

Generally, referring to FIGS. 4A and 4B, the electrostatic hand cleansing apparatus 10 of the present invention is intended to automatically cleanse a hand or hands of a user 11 employing same. For instance, at least one contaminant may be removed from a hand or hands of a user 11 of the electrostatic hand cleansing apparatus 10 byway of fluid or gas passing thereover. In addition or alternatively, at least one undesirable agent occurring on at least one hand may be rendered substantially innocuous by way of exposure to a substance. For instance, a substance having a chemical or biological effect upon the harmful agent may render the at least one undesirable agent substantially innocuous.

During operation, the electrostatic spray nozzle 12 may emit substances supplied from the detergent injection system 150 and/or the substance injection system 170 comprising such as, for instance, air, water, detergent, antibacterial agents, germicidal agents, ethyl alcohol, and/or isopropyl alcohol. In addition, the electrostatic hand cleansing apparatus 10 may cause air to pass over at least one hand of the user 11 thereof, in order to dry as well as remove excess substances therefrom. Specifically, during operation, the electrostatic spray nozzle 12 may combine air and water or a water based solution to atomize the liquid and impart an electrical charge to the droplets thereof. Spray droplets so produced may be of about 30 to 40 microns in size. Further, electrostatic spray nozzle 12 may be configured to produce relatively highly negatively electrically charged droplets. In fact, electrostatic spray nozzle 12 may produce atomized, electrically charged droplets that are attracted to grounded surfaces in significant excess of the force of gravity. For instance, the electrical field produced by the electrically charged atomized spray, as well as the electrical environment surrounding the droplets may produce forces of up to about 75 times the force of gravity on the electrically charged droplets. Such electrical forces may cause at least some of the electrically charged droplets to be attracted to substantially all the surfaces of at least one hand. In doing so, the electrically charged particles may exhibit a so-called “wrap-around effect” where some electrically charged droplets are attracted to and ultimately contact surfaces that would not be contacted by uncharged spray. Thus, the atomized, electrically charged droplets may contact portions of at least one hand that are not directly in the path between the nozzle exit and the collection structure 14 to the droplets.

Although described above as “negatively charged,” droplets that become electrically charged by the electrostatic spray nozzle 12 may be either negatively charged or positively charged, without limitation. The electrical charges on droplets or particles emitted from the electrostatic spray nozzle 12 may be intermittent, reversing, pulsed or otherwise time-varying as desired. In addition, it may be advantageous to charge different substances emitted from the electrostatic spray nozzle 12 with different electrical charges. For instance, exposure of at least one hand to a negatively charged substance may be followed by exposure of at least one hand to a positively charged substance, or visa versa. Also, like-charged substances may tend to repel rather than attract, for instance, exposure of at least one hand to a negatively charged substance may be followed by exposure of the at least one hand to another negatively charged substance. Such a sequence or progression may more effectively remove foreign matter or substances from the at least one hand, may promote mixing or separation of two substances, may more effectively dry the at least one hand, or may selectively adjust the amount of a substance deposited on the at least one hand of a user 11 of the electrostatic hand cleansing apparatus 10.

Also, substances emitted from the electrostatic spray nozzle 12 may be configured depending on the one or more contaminants that are anticipated on at least one hand. Accordingly, the substances emitted by the electrostatic spray nozzle 12 may be chosen according to their chemical properties or characteristics. For example, substances comprising air, water, detergent, antibacterial agents, germicidal agents, ethyl alcohol, and/or isopropyl alcohol may be emitted by electrostatic spray nozzle 12. Of course, the present invention contemplates that desired substances may be delivered in whatever form they may exist, such as gas, liquid, or solid. Since the electrostatic spray nozzle 12 typically includes a liquid and a gas supply, solids that may not readily form solutions may be delivered by dispersion within the liquid or gas supplied to the electrostatic spray nozzle 12.

Therefore, as shown in FIG. 4A, during operation, electrostatic hand cleansing apparatus 10 may apply a substance such as a germicidal or antibacterial substance to at least one hand of a user 11 of the electrostatic cleansing apparatus 10 in response to at least one hand of a user 11 being disposed proximate to sensor 28 (FIGS. 2 and 3). Sensor 28 may comprise a photoelectric sensor that is configured to detect the presence of at least one hand (or another object) proximate thereto (e.g., within a range of about 2 to 3 inches from the sensing aperture thereof). Thus, electrostatic hand cleansing apparatus 10 may apply detergent and/or water to cleanse at least one hand disposed between the electrostatic spray nozzle 12 and the collection structure 14. More specifically, fluids may be emitted from the electrostatic spray nozzle 12, interact with at least one hand disposed between the electrostatic spray nozzle 12 and the collection structure 14 to thereby facilitate removal or neutralize at least one harmful or undesirable substance thereon. Additionally, the at least one hand of a user 11 may be dried. Thus, a substance that contacts a hand of a user 11 of the electrostatic hand cleansing apparatus 10 may be substantially removed therefrom by drying or otherwise.

The present invention also contemplates that a user 11 of electrostatic hand cleansing apparatus 10 may be electrically configured to attract a substance emitted from the electrostatic spray nozzle 12. As shown in FIG. 3, grounding element 29 may provide an electrical ground, such as an earth ground, for a user 11 of electrostatic hand cleansing apparatus 10. Grounding element 29 may be electrically grounded through and mechanically affixed to housing 20 via grounding tether 31. The grounding element 29 may be electrically coupled to a user 11 by placing the grounding element 29 in contact with the skin of the user 11, such as on the upper arm thereof, as shown in FIG. 4A.

However, grounding element 29 may be configured to release from a user 11 of the electrostatic hand cleansing apparatus 10 without direct manipulation thereof. For instance, grounding element 29 may be configured as a U-shaped band that fits about an appendage of the user, such as an arm, and also easily slips off of a user 11 of the electrostatic hand cleansing apparatus 10 as the user 11 pulls away from the grounding element 29. Alternatively, the grounding element 29 may be mounted to the housing 20 and contacted by a user 11 during operation of the electrostatic hand cleansing apparatus 10. The grounding element 29 may be configured to expand and contract in order to ground a user 11. For instance, the grounding element 29 may comprise an expanding and contracting cuff or U-shaped structure. Such a configuration may allow for a user 11 to avoid contaminating a cleansed hand subsequent to operation of the electrostatic hand cleansing apparatus 10. Thus, the grounding element 29 may be configured to be indirectly decoupled from the user 11, either automatically or by impetus of the user 11. Of course, the grounding element 29 may be configured to interlock with the operation of the electrostatic hand cleansing apparatus 10, so that only a grounded user may operate the electrostatic hand cleansing apparatus 10. Such a configuration may improve the effectiveness or safety of the electrostatic hand cleansing apparatus 10.

In another aspect of the present invention, FIG. 4B shows an electrostatic hand cleansing apparatus 51 including a hood 40 positioned about the electrostatic spray nozzle 12 and mounting element 18. Hood 40 may be configured and sized to inhibit the escape of substances emitted from the electrostatic spray nozzle 12 outside of the hood 40. Such a configuration may enhance the exposure of at least one hand of a user 11 to the substances emitted by the electrostatic spray nozzle 12. Of course, hood 40 may be removable or may be configured to selectively deploy. For instance, hood 40 may be retractable or otherwise configured to fold, condense, or compress. Further, hood 40 may be a physical barrier or hood 40 may be electrically configured to capture or retain an electrically charged substance emitted from the electrostatic spray nozzle 12. For instance, hood 40 may be configured to generate an electrical field that effectively constrains the electrically charged emission from the electrostatic spray nozzle 12.

In a further embodiment of the present invention, FIG. 4D shows an electrostatic hand cleansing apparatus 51 as shown in FIG. 4A, including a grounding mat 50. Grounding mat 50 may be electrically grounded through housing 20 or other electrically grounded fixture, as known in the art. If suitably configured, in combination with suitably configured (electrically conductive or otherwise electrically grounding) shoes 53 of user 11, grounding mat 50 may effectively ground a user 11 of the electrostatic hand cleansing system 10. Optionally, grounding mat 50 may include a grounding element 52 electrically coupled thereto, configured for attachment to user 11, for instance to a shoe 53 of user 11, as shown in FIG. 4D. Grounding element 52 may be electrically grounded through and mechanically affixed to grounding mat 50 via grounding tether 33 and configured for electrically grounding a user 11 of electrostatic hand cleansing apparatus 10. Thus, grounding mat 50 may provide an electrical ground, such as an earth ground, for a user 11 of electrostatic hand cleansing apparatus 10.

In yet a further aspect of the present invention, while the above-described embodiments of electrostatic hand cleansing apparatus 10 are shown as including a single electrostatic spray nozzle 12, the present invention is not so limited. Rather, an electrostatic hand cleansing apparatus 10 of the present invention may include one electrostatic spray nozzle 12, at least one electrostatic spray nozzle 12, or a plurality of electrostatic spray nozzles 12, without limitation. For instance, FIG. 4E shows an electrostatic hand cleansing apparatus 10 as described hereinabove with respect to FIG. 4A, including electrostatic spray nozzles 12. Such a configuration may provide the ability to deliver different substances or differently charges substances substantially simultaneously to at least one hand of a user 11. Alternatively or additionally, electrostatic spray nozzles 12 may provide a greater overall delivery rate of at least one substance to at least one hand of a user 11. Of course, optionally, electrostatic spray nozzles 12 may be directed toward different regions of at least one hand of a user 11 or regions proximate thereto, including, for example, at least one hand thereof, at least a portion of an arm thereof, or combinations thereof. Further, collection structure 14B and aperture 15B may be sized, positioned, and configured appropriately for retention and capture of emissions from the electrostatic spray nozzles 12.

As mentioned above, water system 110, air system 130, detergent injection system 150, substance injection system 170, and blower system 190 may be configured as systems comprising the electrostatic hand cleansing apparatus 10. Such water system 110, air system 130, detergent injection system 150, substance injection system 170, and blower system 190 may be configured to operate in relation to the electrostatic hand cleansing apparatus 10. For instance, systems of the electrostatic hand cleansing apparatus 10 may supply substances to the electrostatic hand cleansing apparatus 10 as well as remove substances therefrom during operation thereof. Accordingly, filters, pumps, valves, measurement devices, control devices and other associated apparatus may be employed within systems of the electrostatic hand cleansing apparatus 10, as outlined below.

Referring to FIG. 5, water system 110 includes water source 112, manual valve element 101, valve element 114, purification element 116, heating element 118, flow orifice 123, check valve 119, temperature measurement device 122, pressure measurement device 124, and output 125. Water source 112 may be a municipal water supply or may be a pump that delivers pressurized water to electrostatic hand cleansing apparatus 10, for instance, to the at least one electrostatic spray nozzle 12. Further, valve elements 101 and 114 may each be configured to selectively allow or prevent the flow of water within the water system 110. Of course, water system 110 may include one or both of valve elements 101 and 114, as desired. Manual valve 101 may comprise a manually operated valve as known in the art, such as, for instance, a so-called ball valve, as known in the art. Valve element 114 may comprise a flow control device as known in the art, such as, for instance, a solenoid valve. Purification element 116 may be configured to remove from or ameliorate at least one contaminant within the water passing therethrough and may include a filtration system, reverse osmosis system, ultraviolet light system, or any combination thereof. Heating element 118 may comprise water heating devices as known in the art, such as, for instance, a water heater. Heating element 118 may comprise a tankless or instantaneous water heater in order to minimize the size thereof. Also, pressure regulation device 120 may be configured to control, limit, or prescribe the pressure within output 125 of water system 110, and may comprise a pressure regulator as known in the art. Optionally, a flow orifice 123 may be included within water system 110 for regulating the rate at which water flows therethrough, for a given pressure. Further, water system 110 may include check valve 121, which may be configured to allow water flow in one direction and substantially prevent water flow in the opposite direction, as known in the art. Temperature measurement device 122 and pressure measurement device 124 may each be configured to measure and indicate (visually, electrically, or otherwise) the temperature and pressure of the water, respectively. A preferable temperature for water within the water delivery system may be about 38 to 42 degrees Celsius in order to reduce organisms therein. Output 125 of water system 110 may be configured to deliver water to any component of electrostatic hand cleansing apparatus 10. Optionally, a pressure switch (not shown) may be positioned within water system 110 and may be used as an electrical control or safety device. Explaining further, for instance, a pressure switch may selectively allow the at least one electrostatic spray nozzle 12 to be energized. Further, pressure switch may only allow the at least one electrostatic spray nozzle 12 to be energized when the pressure of the water is within a range of magnitudes. Thus, output 125 of water system 110 may supply water to the at least one electrostatic spray nozzle 12. Alternatively, water supplied from the water delivery system may be omitted during any operative cycle if the substance emitted adequately functions without additional water. Of course, a water system 110 may be provided for each electrostatic spray nozzle 12, if more than one is present, if desired.

Similarly, referring to FIG. 6, air system 130 includes air source 132, manual valve element 111, valve element 134, purification element 136, heating element 138, pressure regulation element 140, check valve 142, pressure switch 144, pressure measurement device 146, and output 147. Air source 132 may be typically be a source of compressed air such as an air compressor that delivers pressurized air to electrostatic hand cleansing apparatus 10. Pressurized air may be used by the at least one electrostatic spray nozzle 12 to atomize a fluid passing therethrough. Valve elements 111 and 134 may each be configured to selectively allow or prevent the flow of air within the air system 130. Air system 130 may include one or both of valve elements 111 and 134, as desired. Manual valve 111 may comprise a manually operated valve as known in the art, such as, for instance, a so-called ball valve, as known in the art. Valve element 134 may comprise a flow control device as known in the art, such as, for instance, a solenoid valve. Purification element 136 may be configured to remove from or ameliorate at least one contaminant within the air passing therethrough, may filter, exposed to ultraviolet light, disinfect, or otherwise sterilize the air to remove at least one contaminant supplied to the electrostatic hand cleansing apparatus 10. Accordingly, substantially bacteria and particle free air and water may be preferred for use in the electrostatic hand cleansing apparatus 10 of the present invention. Further, use of filtration and or purification systems may allow for reuse of some of the substances emitted from the at least one electrostatic spray nozzle 12, if desirable. Heating element 138 may comprise air heating devices as known in the art. Pressure regulation device 120 may comprise an air pressure regulator as known in the art. Air system 110 may also include check valve 142, which may be configured to allow air flow in one direction and substantially prevent air flow in the opposite direction, as known in the art. Pressure switch 144 may be used as an electrical control or safety device. Explaining further, the pressure switch 144 may selectively allow the at least one electrostatic spray nozzle 12 to be energized. For instance, pressure switch may only allow the at least one electrostatic spray nozzle 12 to be energized when the pressure near the outlet 147 of the air system 130 is within a range of magnitudes. Such a configuration may be an indication that air is flowing through the nozzle, and may prevent overheating interior components of the at least one electrostatic spray nozzle 12. Alternatively or additionally, control or safety devices may be included within the electrostatic hand cleansing apparatus 10 of the present invention and may include flow measurement devices, temperature measurement devices, pressure measurement devices, or other measurement devices or safety devices as known in the art. Pressure measurement device 146 may be configured to measure and indicate (visually, electrically, or otherwise) the pressure of the air. Output 147 of air system 130 may be configured to deliver air to any component of electrostatic hand cleansing apparatus 10. For instance, output 147 of air system 130 may supply air to the at least one electrostatic spray nozzle 12.

The present invention is not limited to cleansing at least one hand by way of substances emitted from at least one electrostatic spray nozzle exclusively. Rather, substances may be delivered via at least one electrostatic spray nozzle 12 or via other delivery mechanisms. For instance, focused or directed water from a conventional nozzle may more effectively impinge on the surface of at least one hand to remove foreign material therefrom. Also, highly directed air forming a compact spray pattern that travels within an envelope thereby producing a so-called air curtain or air-knife may be advantageous to utilize within the electrostatic hand cleansing apparatus 10 of the present invention.

Alternatively, the at least one electrostatic spray nozzle 12 of the electrostatic hand cleansing apparatus 10 may be used to expose at least one hand of a user to any or all of the hand cleansing and/or drying substances that are utilized thereby. Such a configuration may allow for reduction of the amount of detergent, sanitizer, disinfectant, anti-bacterial, or any other substance, which may reduce damage that may occur from repeated cleansing of at least one hand. Also, such reduction may provide correlative cost savings in reducing the amount of cleansing substances consumed by the cleansing process. Air drying of at least one hand may eliminate the cost and abrasiveness of paper towels or other absorbent media that may be used to physically contact and thereby dry the at least one hand.

Turning to FIG. 7, detergent may be supplied to the electrostatic hand cleansing apparatus 10 of the present invention via the output 159 of detergent injection system 150. Detergent injection system 150, as shown in FIG. 7, may include pump 154, tank 152, level switch 156, and flow switch 158. Output 159 of detergent injection system 150 may hydraulically communicate with the output 125 of water delivery system 110, the combination of which may hydraulically communicate with at least one electrostatic spray nozzle 12. Of course, output 159 may be regulated by way of a valve, such as a manual needle valve, or by automatic control via a process control feedback loop as known in the art. Accordingly, detergent may be delivered to and thereby emitted from the at least one electrostatic spray nozzle 12 at a desired rate. Tank 152 may be sized and configured to contain an amount of detergent for use by electrostatic hand cleansing apparatus 10 and level switch 156 may be used to indicate a relative amount of detergent within tank 152. Flow switch 158 may be used to indicate a rate of flow of detergent, if desired.

As shown in FIG. 8, substance injection system 170 may be provided to supply a substance to the electrostatic hand cleansing apparatus 10 of the present invention via output 181 of substance injection system 170. Similar to the detergent injection system 150, substance injection system 170 may include pump 174, tank 172, level switch 176, and flow switch 178. Output 181 of substance injection system 170 may hydraulically communicate with the output 125 of water delivery system 110, the combination of which may hydraulically communicate with at least one electrostatic spray nozzle 12. Output 181 may be regulated by way of a manual valve or by automatic control as known in the art. Therefore, a substance may be delivered to and thereby emitted from the at least one electrostatic spray nozzle 12 at a desired rate. Tank 172 may be sized and configured to contain an amount of substance for use by electrostatic hand cleansing apparatus 10 and level switch 176 may be used to indicate a relative level of substance within tank 172. Flow switch 178 may be used to indicate a rate of flow of the substance, if desired.

The detergent injection system 150 and substance injection system 170 may be combined if mixing the desired substances is compatible. Such a configuration may allow for one pump to force such a mixture through the at least one electrostatic spray nozzle 12. However, it may be desirable, as illustrated above, to separate particular substances from one another. Therefore, as may be appreciated, the electrostatic hand cleansing apparatus 10 of the present invention may include multiple systems analogous to the detergent injection system 150 or substance injection system 170. Alternatively, the electrostatic hand cleansing apparatus 10 of the present invention may include a single injection system configured to deliver a substance through the at least one electrostatic spray nozzle 12. Of course, such a system may not necessarily include a pump, as the water source 112 of the water system 110 may supply water flow and pressure necessary to deliver a substance in addition to water through the at least one electrostatic spray nozzle 12.

FIG. 9 shows a blower system 190 of the present invention, including, input 191, motor 192, blower 198, check valve 195, liquid removal member 194, liquid output 197 noise reduction element 196, and gas output 199. Generally the blower system 190 may be configured to remove excess charged droplets emitted from the at least one electrostatic spray nozzle during emission therefrom, as desired. Input 191 may be operably coupled to conduit 16 of electrostatic hand cleansing apparatus 10, as shown in FIGS. 1-4B. Such a configuration may draw air inwardly from the edges of the collection structure 14, thus entraining charged droplets emitted from the at least one electrostatic spray nozzle 12. Also, motor 192 and blower 198 may be coupled so that by energizing motor 192 blower 198 draws gas from input 191 and forces gas through blower system 190. Specifically, gas may pass through check valve 195, where check valve 195 may be configured to allow flow therethrough toward output 199. Also, gas exiting blower 198 may be caused to pass through liquid removal member 194. Liquid removal member 194 may be configured to remove liquid from the gas passing therethrough, where the liquid may be in the form of humidity or droplets within the gas stream. Further, liquid output 197 from liquid removal member 194 may be coupled to conduit 16, wherein liquid may be allowed to exit into an external drain, as described above. However, liquid removal member 194 may not be used or included within blower system 190 if so desired. Alternatively, a liquid removal member 194 may be installed within the input 191, prior to the gas passing through the blower 198. Liquid removal member 194 may comprise a filter, a baffle assembly, a cooled assembly, or any liquid removal apparatus for removing liquid from a gas stream as known in the art. Further, blower 198 may cause gas to pass through diffusion element 196. Diffusion element 196 may be configured to reduce the noise or velocity of gas exiting from the output 199 of the blower system 190. Of course, many configurations for diffusion element 196 may be used, for instance, a damper or a baffle assembly.

Accordingly, any of the components of the above-mentioned systems may be adjusted, controlled, monitored, or energized by a microprocessor, PLC, or other control mechanism. Control of such processes may preferably be configured to operate the electrostatic hand cleansing apparatus 10 automatically. Particularly, a sensor 28, as described above, may trigger the beginning of a predetermined or preselected cleansing process. Explaining further, the electrostatic hand cleansing apparatus 10 may be caused to operate according to different processes that include operational cycles as explained below.

For instance, a detergent cycle, rinse cycle, sanitize cycle, and dry cycle of the electrostatic hand cleansing apparatus 10 may be configured to expose at least one hand of a user 11 to different substances. Particularly, a rinse cycle may cause air and water only flow through the at least one electrostatic spray nozzle 12; a detergent cycle may cause air, heated water, and detergent to flow through the at least one electrostatic spray nozzle 12; a sanitizing cycle may cause air, water, and sanitizer to flow through the at least one electrostatic spray nozzle 12; and a drying cycle may cause heated air to flow through the at least one electrostatic spray nozzle 12. Additionally, the amounts of substances emitted as well as length of time that the substances are emitted may be selected and altered according to the desired results. Thus, the operative processes or cycles of the electrostatic hand cleansing apparatus 10 may be configured for achieving desired results.

The electrostatic hand cleansing apparatus 10 of the present invention is not limited in the amount, duration, or manner in which the substances are applied. Rather, the electrostatic hand cleansing apparatus 10 of the present invention may utilize substances that facilitate removal of at least one contaminant or render at least one harmful agent substantially harmless. Of course, different cleansing process configurations may be selected according to the cleansing desired. Further, different processes may be selectable by interaction with the sensor 28, a foot pedal, or by voice recognition, or other interaction with a user 11. Alternatively, sensor 28 may be configured to measure the relative contamination present on at least one hand of a user and automatically determine and select an appropriate cleansing process. Such contamination measurement may be subsequently repeated as well as corresponding cleansing process repetition, if needed, to ensure a proper level of cleanliness is achieved.

In another aspect of the present invention an automatic self-cleansing cycle may be configured to maintain the relative sterility of the electrostatic hand cleansing apparatus 10, especially during extended periods of non-use. Thus, the electrostatic hand cleansing apparatus 10 may be configured to periodically emit sanitizer, water, air, and/or other substances in order to maintain relative cleanliness or sterility. For instance, a self-cleaning cycle may be activated via a timer that is preset to operate the electrostatic hand cleansing apparatus 10 at specified intervals from the last use thereof. A self-cleaning cycle may reduce the presence of bacteria on the electrostatic hand cleansing apparatus 10 during periods of non-use.

Although specific embodiments have been shown by way of example in the drawings and have been described in detail herein, the invention may be susceptible to various modifications, combinations, and alternative forms. Therefore, it should be understood that the invention is not intended to be limited to the particular forms disclosed. Rather, the invention includes all modifications, equivalents, combinations, and alternatives falling within the spirit and scope of the invention as defined by the following appended claims.

1. A cleansing apparatus for cleansing at least one hand of a user comprising:
at least one electrostatic spray nozzle including an emission tip configured to emit an atomized, electrically charged substance;
a collection structure defining a recess having a depth, the collection structure recess oriented generally oppositely to the expected direction of the atomized, electrically charged substance emission of the at least one electrostatic spray nozzle.

2. The cleansing apparatus of claim 1, further comprising a sensor configured to indicate the presence of at least one hand positioned generally between the at least one electrostatic spray nozzle and the collection structure.

3. The cleansing apparatus of claim 2, wherein the sensor comprises a photoelectric sensor configured to indicate the presence of at least one hand generally between the at least one electrostatic spray nozzle and the collection structure.

4. The cleansing apparatus of claim 1, wherein the at least one electrostatic spray nozzle emission tip is positioned in relation to the collection structure within about two times of the depth of the recess thereof.

5. The cleansing apparatus of claim 1, wherein the recess of the collection structure comprises a partial generally hemispherical recess.

6. The cleansing apparatus of claim 5, wherein the at least one electrostatic spray nozzle emission tip is positioned in relation to the collection structure within about two times the depth of the recess thereof.

7. The cleansing apparatus of claim 1, wherein the collection structure is configured to selectively electrically attract or repel the atomized, electrically charged substance emitted from the at least one electrostatic spray nozzle.

8. The cleansing apparatus of claim 7, wherein the collection structure comprises an electrical insulator.

9. The cleansing apparatus of claim 1, further comprising a grounding element for electrically grounding the user.

10. The cleansing apparatus of claim 9, wherein the grounding element is configured to indirectly release from the user.

11. The cleansing apparatus of claim 10, wherein the grounding element is configured as a U-shaped band sized and configured to engage a portion of the user.

12. The cleansing apparatus of claim 9, wherein the grounding element is electrically connected to a grounding mat.

13. The cleansing apparatus of claim 12, wherein the grounding element is configured for attaching to a shoe of the user.

14. The cleansing apparatus of claim 1, further comprising a hood sized and configured to influence the distribution of the atomized, electrically charged substance emitted from the at least one electrostatic spray nozzle.

15. The cleansing apparatus of claim 14, wherein the hood is configured to electrically influence the atomized, electrically charged substance emitted from the at least one electrostatic spray nozzle.

16. The cleansing apparatus of claim 1, wherein the at least one electrostatic spray nozzle comprises a plurality of electrostatic spray nozzles.

17. The cleansing apparatus of claim 1, further comprising an aperture formed within the collection structure.

18. The cleansing apparatus of claim 17, wherein the aperture is sized and configured for drawing gas therethrough from within the recess of the collection structure.

19. The cleansing apparatus of claim 18, wherein the aperture is sized and configured for drawing gas therethrough from within the recess of the collection structure in relation to an expected distribution of the atomized, electrically charged substance emission from the at least one electrostatic spray nozzle so as to substantially capture the emission from the at least one electrostatic spray nozzle by way of the collection structure.

20. A method of cleansing at least one hand, comprising:
providing at least one electrostatic spray nozzle having an emission tip;
providing a collection structure having a recess including a depth;
disposing the collection structure generally oppositely to an expected direction of emission of the at least one electrostatic spray nozzle;
sensing the presence of at least one hand generally between the at least one electrostatic spray nozzle and the collection structure recess;
exposing the at least one hand to at least one electrically charged substance emitted from the at least one electrostatic spray nozzle.

21. The method of claim 20, wherein exposing the at least one hand to at least one electrically charged substance emitted from the at least one electrostatic spray nozzle comprises removing at least one contaminant from the at least one hand.

22. The method of claim 20, wherein providing a collection structure disposed generally oppositely to the expected direction of emission of the at least one electrostatic spray nozzle comprises configuring the collection structure so that the at least one electrostatic spray nozzle emission tip is positioned in relation to the collection structure within about two times of the depth of the recess thereof.

23. The method of claim 20, wherein exposing the at least one hand to at least one electrically charged substance emitted from the at least one electrostatic spray nozzle comprises causing at least one undesirable agent to become substantially innocuous.

24. The method of claim 20, further comprising drawing gas from the recess of the collection structure.

25. The method of claim 20, further comprising altering an electrical characteristic of the collection structure so as to attract or repel the at least one electrically charged substance emitted from the at least one electrostatic spray nozzle.

26. The method of claim 25, wherein altering the electrical characteristic of the collection structure comprises electrically grounding the collection structure.

27. The method of claim 20, further comprising altering an electrical characteristic of the at least one hand so as to attract or repel the at least one electrically charged substance emitted from the at least one electrostatic spray nozzle.

28. The method of claim 27, wherein altering the electrical characteristic of the at least one hand comprises electrically grounding the at least one hand.

29. The method of claim 20, wherein exposing the at least one hand to at least one electrically charged substance emitted from the at least one electrostatic spray nozzle comprises exposing the at least one hand to a first electrically charged substance and exposing the at least one hand to a second electrically charged substance.

30. The method of claim 29, further comprising electrically charging the first and second electrically charged substances differently.

31. The method of claim 20, wherein:
providing at least one electrostatic spray nozzle having an emission tip comprises providing a plurality of electrostatic spray nozzles each having an emission tip, respectively; and
exposing the at least one hand to at least one electrically charged substance emitted from the at least one electrostatic spray nozzle comprises exposing the at least one hand to at least one electrically charged substance emitted from each of the plurality of electrostatic spray nozzles.

32. The method of claim 31, wherein exposing the at least one hand to the at least one electrically charged substance emitted from each of the plurality of electrostatic spray nozzles comprises removing at least one contaminant from the at least one hand.

33. The method of claim 31, wherein exposing the at least one hand to the at least one electrically charged substance emitted from each of the plurality of electrostatic spray nozzles comprises causing at least one undesirable agent to become substantially innocuous.

34. The method of claim 31, wherein exposing the at least one hand to the at least one electrically charged substance emitted from each of the plurality of electrostatic spray nozzles comprises exposing the at least one hand to one electrically charged substance emitted through a respective electrostatic spray nozzle of the plurality of electrostatic spray nozzles substantially simultaneously.

35. The method of claim 34, wherein the one electrically charged substance of the respective electrostatic spray nozzle of the plurality of electrostatic spray nozzles is electrically charged differently from each other of the one electrically charged substance of the respective electrostatic spray nozzle of the plurality of electrostatic spray nozzles.

36. The method of claim 20, wherein sensing the presence of at least one hand generally between the at least one electrostatic spray nozzle and the collection structure comprises measuring a contamination characteristic of the at least one hand.

37. The method of claim 20, further comprising removing gas from an aperture formed within the collection structure.
